(19) United States
(12) Patent Application Publication
(10) Pub. No.: US 2016/0258806 A1
(43) Pub. Date: Sep. 8, 2016

(54) Device and Method of Communicating with a Bathroom Scale

(71) Applicant: Camry Industries Company Limited, Hong Kong (CN)

(72) Inventor: Chun-Chun Chiu, Hong Kong (CN)

(21) Appl. No.: 14/636,599

(22) Filed: Mar. 3, 2015

(51) Int. Cl. G01G 23/37

(52) U.S. Cl. CPC G01G 23/3742

(57) ABSTRACT

A smart phone containing an application capable of communicating wirelessly with an electronic bathroom scale. From the application, the user can select his user account. By a slight shaking of the smart phone, the application will automatically and wirelessly select the same user account in the bathroom scale, and synchronize personal data from the application to the bathroom scale.

### TECHNICAL FIELD OF THE INVENTION

The present invention relates to a weighing scale. In particular, the invention relates to a method for remote controlling and viewing measurement data on the weighing scale, and more particularly to a bathroom scale.

### BACKGROUND OF THE INVENTION

A traditional bathroom scale is typically provided in the form of a shallow slab typically in the shape of a square in the plan view, and has a surface upon which a person may stand. Placed along one side of the surface is a graduated scale marked with numbers to show weight. The bathroom scale contains a mechanism for moving the graduated scale to display the weight of a person standing on the bathroom scale.

Improvements over the traditional bathroom scale include computerization and addition of functions. For example, electronic bathroom scales measure more information than just the weight of the person on it, and may measure other physical data such as fat-to-muscle ratio, bodily water percentage and so on. Furthermore, electronic bathroom scales are able to store identity of different users so that the users may track their physical changes over time.

An electronic bathroom scale typically has a liquid crystal diode display placed where the graduated scale would be in a traditional bathroom scale. Press buttons are provided which allow users to enter their identity into the electronic bathroom scale, and to enter some of his personal data such as height and age into a memory in the electronic bathroom scale.

A major inconvenience of both the traditional and electronic bathroom scales is that the user has to look down to read his weight, which is difficult for elderly people or people with a weight or back problem. Attempts to overcome this inconvenience produced standing weighing scales. However, standing weighing scales are not suitable for home use as they cannot be tucked under furniture.

Accordingly, it is desirable to provide a method to help users better utilize electronic bathroom scales.

### SUMMARY

In the first aspect, a method of communicating with a bathroom scale, comprising the step of: providing a remote controller, establishing communication between a bathroom scale and the remote controller, allowing a user to select a user account on the remote controller, using the remote controller to obtain the reading on the bathroom scale, and displaying the reading on the remote controller.

A remote controller display allows the user to read weight measured by the bathroom scale without having to bend down to read the display on the bathroom scale. This allows people with back or knee problems, or people with extreme weight issue or other kinds of inconveniences to use the bathroom scale easily. Furthermore, this allows the user to interact with the bathroom scale remotely. In contrast, other such bathroom scales in the market require the user to physically touch or press buttons on the bathroom scales in order to scroll through options or to retrieve the information of any particular user account.

Preferably, the bathroom scale has a memory suitable for storing records of the weight of a plurality of users, further comprising the step of: uploading data in the memory of the bathroom scale into the remote controller.

In this case, each person's historical records of physical data can be grouped together and read on the remote controller.

Preferably, the communication between the remote controller and the bathroom scale is wireless. In alternative embodiments, the remote controller can be wired to the bathroom scale.

Preferably, the remote controller is a portable device, such as a smart phone. This allows any smart phone to be adapted for use with the bathroom scale by being installed with a suitable application. A smart phone is one which is capable of performing computing functions in addition to being a mobile telephone, into which software applications can be installed.

Preferably, the method further comprises the step of: shaking the smart phone to trigger an application suitable for the establishing of communication between the bathroom scale and the remote controller, wherein the step of allowing the user to select his user account on the remote controller includes the triggered application identifying the owner of the smart phone as the current user of the bathroom scale.

A shaking action is easy to execute, compared to pressing on buttons presented as graphical user interface. Therefore, a user can simply shake the smart phone and the weight of the user can be retrieved from the bathroom scale and transferred into the smart phone.

In a second aspect, a remote controller obtains physical data from a bathroom scale, wherein the remote controller is configured to communicate with the bathroom scale, and the remote controller is useable to select a user account for use with the bathroom scale.

In various embodiments, such a remote controller can be produced by a different manufacturer from that of the bathroom scale, allowing more expedient production logistics.

Preferably, the bathroom scale has a memory suitable for storing records of the weight of a plurality of users, and the remote controller is configured to communicate with the bathroom scale in order to upload data in the memory of the bathroom scale into the remote controller.

Preferably, the remote controller is capable of communicating with the bathroom scale wirelessly. Preferably, the remote controller is a portable device such as a smart phone.

Preferably, the smart phone is able to detect a user shaking the smart phone, the smart phone configured to trigger an application suitable for the establishing of communication between the bathroom scale and the remote controller when the shaking is detected, and the remote controller is useable to select an user account for use with the bathroom scale by means of the triggered application identifying the user to the bathroom scale.

In a third aspect, a bathroom scale comprises a transducer for uploading data obtained by the bathroom scale to the remote controller.

Preferably, the bathroom further comprises: a memory suitable for storing records of the weight of a plurality of users, wherein the wireless communication transducer is configured to detect a user identity transmitted from the remote controller, such that the wireless communication transducer uploads data obtained by the bathroom scale of the identified user to the remote controller.

Preferably, the transducer is a wireless transducer. Preferably, the remote controller is a portable device such as a smart phone.

### BRIEF DESCRIPTION OF THE DRAWINGS

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 illustrates a conventional weighing scale;

FIGS. 2 and 2a show the display of the weighing scale of FIG. 1 in body fat measurement mode;

FIG. 3 shows an icon to trigger an application used in an embodiment of the present invention;

FIG. 4 shows the application of FIG. 3 in use;

FIG. 4a illustrates the application of FIG. 3 in a handheld phone;

FIG. 5 shows an interface provided by the application of FIG. 3;

FIG. 6 shows use of a handheld phone which is part of the embodiment of the invention of FIG. 3;

FIG. 7 shows the operation of a weighing scale of the embodiment of the invention of FIG. 3;

FIG. 8 shows another interface provided by the application of FIG. 3;

FIG. 9 shows another interface provided by the application of FIG. 3; and

FIG. 10 is a schematic diagram of the internal structure of the embodiment of the invention of FIG. 3.

### DETAILED DESCRIPTION OF THE EMBODIMENTS

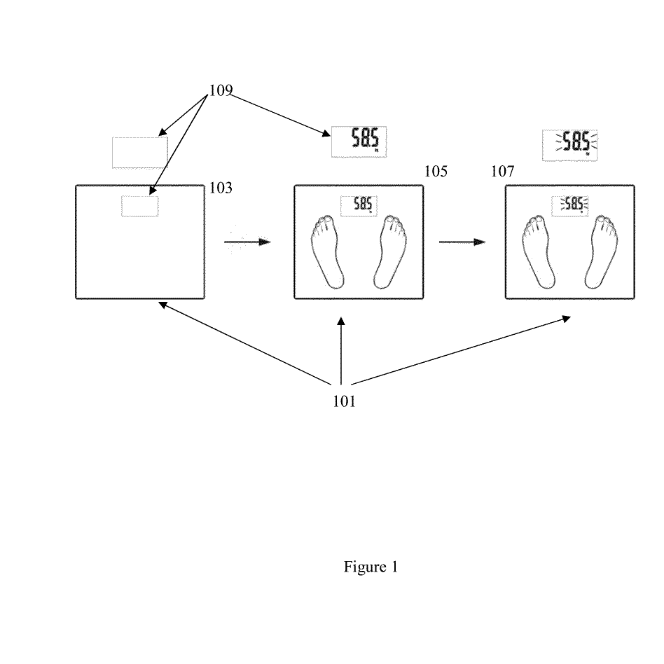

FIG. 1 is a comparative example showing how an electronic bathroom scale 101 operates to measure the weight of a user. As with most bathroom scales 101, the one shown is in the form of a square, shallow plate. A crystal liquid diode (LCD) display 109 is provided near one side of the bathroom scale 101.

The left most drawing 103 in FIG. 1 shows that when the bathroom scale 101 is in power OFF mode or sleep mode, no value is shown in the display 109. The middle drawing 105 illustrates that the display 109 shows an indication of the weight detected when a person steps onto the bathroom scale 101. Typically, it takes a few seconds before the weight reading stabilizes. The rightmost drawing 107 in FIG. 1 shows that the display 109 blinks a few times to let the user know when weight measurement has stabilized.

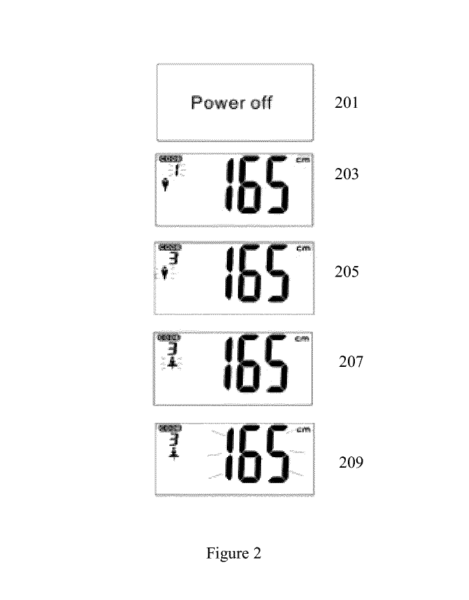

FIGS. 2 to 2a illustrate another comparative example, showing the same bathroom scale 101 used in an OFF mode. In the OFF mode, the weight of the user is not measured. Instead, Body Fat, Body Hydration, Bone Mass, Muscle Mass and Calories consumption are measured. In step 201, the display 109 shows nothing because the bathroom scale 101 is power OFF. The user then presses a ‘Set’ button on the bathroom scale 101. The ‘Set’ button is not illustrated in the drawings but the skilled man knows that it is typically placed next to or near the display 109. Pressing the ‘Set’ button causes the bathroom scale 101 to initiate, for example, the Body Fat Measuring mode.

The bathroom scale 101 contains a memory which stores a number of user accounts. There are typically about 1 to 12 accounts. In steps 203 to 205, the user uses an ‘Up’ and a ‘Down’ button to scroll to his user account; the Figures show the display 109 being scrolled through account 1 to account 3. To confirm the user account he selects, the user presses the ‘Set’ button. Then the bathroom scale 101 automatically enters the ‘Gender Selection’ mode.

In step 207, the user uses the ‘Up’ and ‘Down’ buttons to select his gender. In step 209, the user presses the ‘Set’ button to confirm his gender selection. The bathroom scale 101 then automatically enters into the ‘Height setting’ mode.

In step 211, the user uses the ‘Up’ and ‘Down’ buttons to scroll through a number display and selects the value which shows his height. Then, the user presses the ‘Set’ button to confirm his height selection. The display 109 then automatically enters into the ‘Age’ setting mode.

Then, in step 213, the user uses the ‘Up’ and ‘Down’ buttons to select his age. In step 215, the user presses ‘Set’ to confirm his selected age. After completing the above steps, the data entry for one user account is completed.

Optionally, the user may set up another user account for another user by pressing ‘Up’ and ‘Down’ button to scroll to another user account and repeating the steps from Step 203.

After the user account has been set up, the user steps onto the bathroom scale, in step 217. Beginning in step 219, the bathroom scale 101 begins to start measuring Body Fat, Body Hydration, Bone Mass, Muscle Mass and Calories consumption. In step 221, the display 109 indicates all the measured results in a loop repeatedly for 3 times and then automatically shuts down.

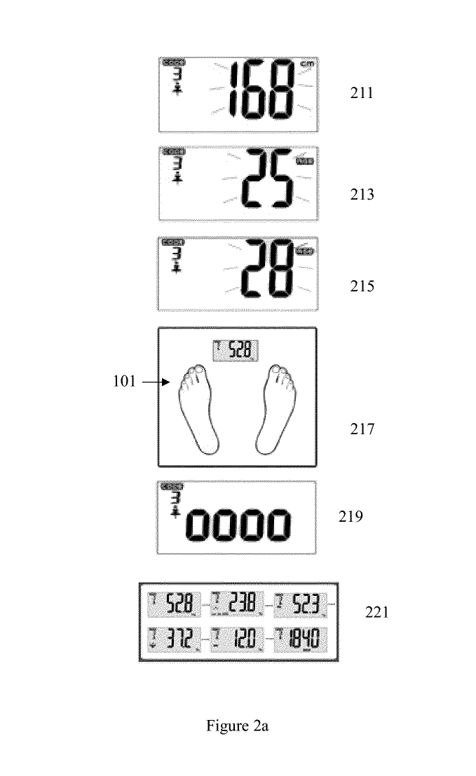

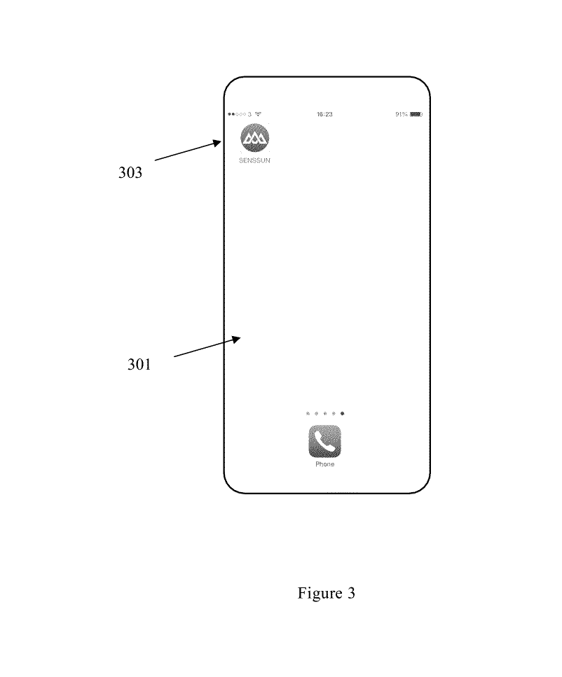

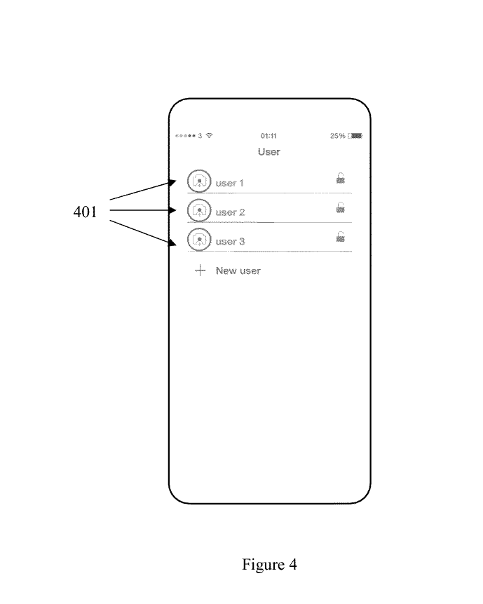

FIG. 4a shows a part of the embodiment, which is an application installed in a smart phone 229 capable of communicating with the bathroom scale. FIG. 3 shows that an icon 303 in the touch sensitive screen 301 of the smart phone 229 for launching the application. Before using the application, however, the user has to ensure that Bluetooth™ in the smart phone 229 is turned on. The application is launched by touching the smart phone 229 screen where the icon 303 is displayed.

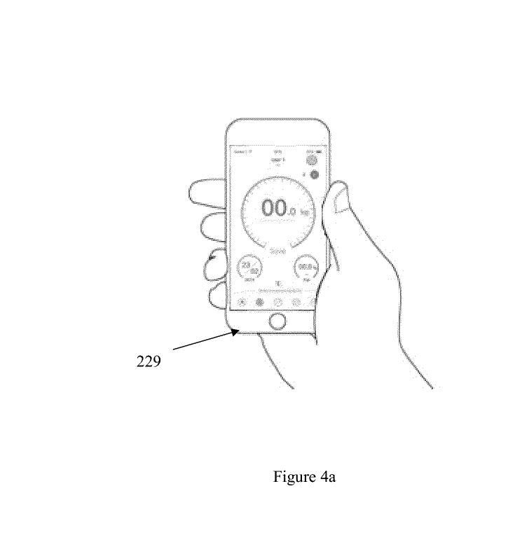

The user can set all personal data via the application in the same way as it is done directly on the bathroom scale. FIG. 4 shows a page in the application, in which user can choose his user account 401 from among several accounts 401. After selecting his account, the graphical user interface turns to show a scale as illustrated in FIG. 5. Then, the user steps onto the bathroom scale 101 which automatically turns the bathroom scale 101 on into the weighing mode, and measures the user's weight as shown in FIG. 1.

Based on the current Bluetooth technology, the application in the smart phone 229 is able to automatically connect with the bathroom scale 101 over a distance of less than 15 feet.

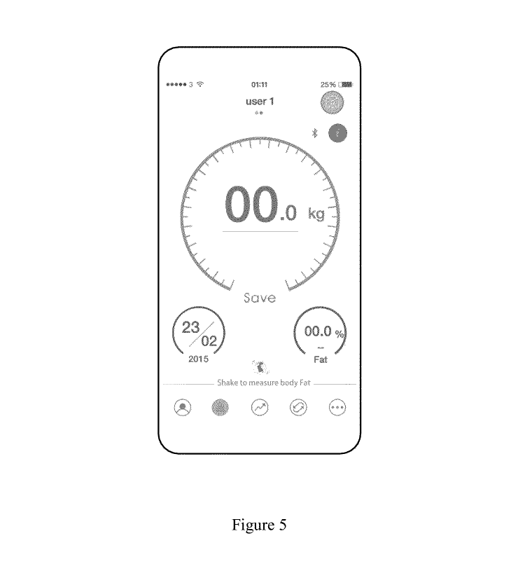

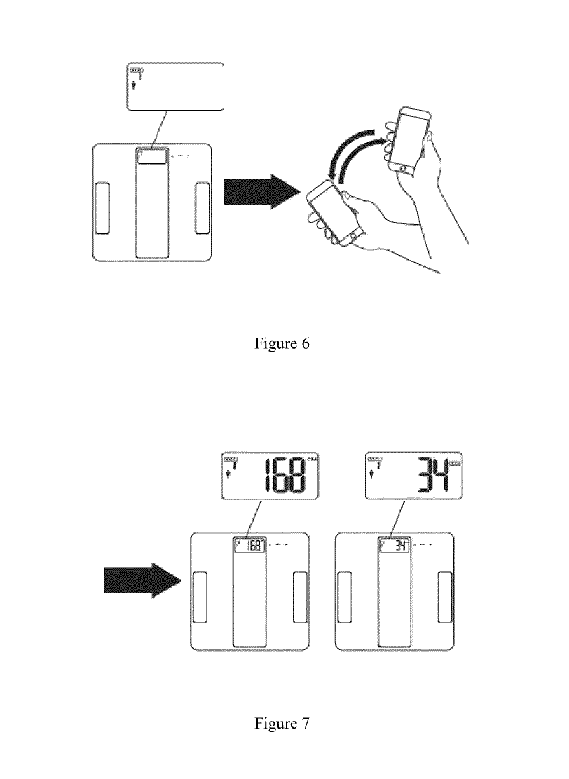

The smart phone 229 is installed with a movement detector, which can be in any form of relevant technology known in the art, such as an accelerometer. FIG. 6 shows that by a slight shaking of the smart phone 229, the application in the smart phone 229 will automatically and wirelessly indicate the selected user account 401 to the bathroom scale 101, which displays it in its LCD display 109. As shown in FIG. 7, the smart phone 229 then synchronizes or transfers personal data, such as height, of the selected user account 401 to the bathroom scale 101. Personal data sent by the application overwrites those stored in the bathroom scale under the same user account 401. More specifically, FIG. 7 shows transmission of height at 160 cm and age 34 into the bathroom scale 101.

Preferably, only a force detected by the accelerometer in the smart phone 229 greater than a certain threshold value is considered part of a shaking movement. Any lesser force will be considered simply casual movements and will not trigger any functions of the application. More preferably, as shaking movements typically comprises a repetition of the same movement and its opposite movement, the accelerometer may be required to detect back and forth movements above a certain acceleration to consider that it has detected a shaking movement.

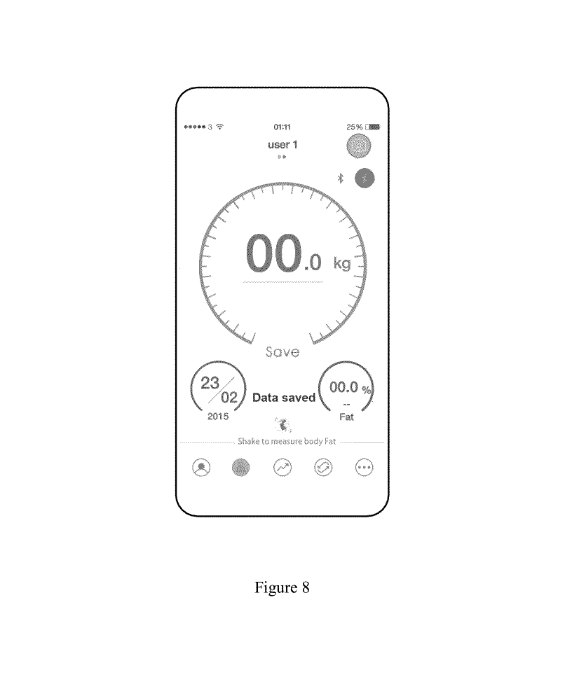

When the user steps onto the bathroom scale 101 to obtain a weight measurement, data will be automatically transmitted from the bathroom scale to the smart phone 229 and displayed in the application, as shown in FIG. 8.

In a variation of the embodiment, it is possible that the user steps on the bathroom scale first before he shakes the smart phone 229 to transmit data between the bathroom scale 101 and the smart phone 229.

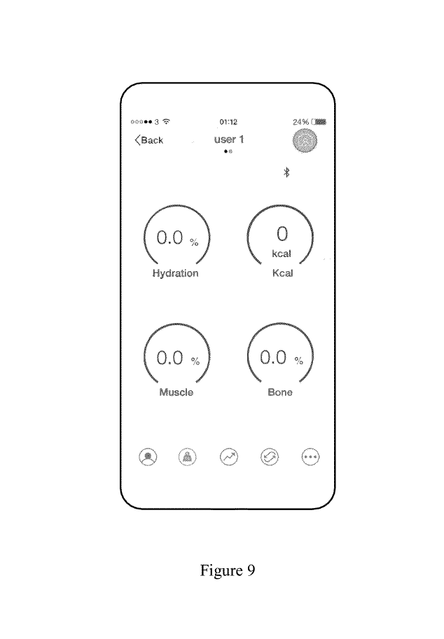

Even though the user's weight is displayed in the application in the smart phone 229, the weight of the user will only be stored inside the memory of the bathroom scale 101 but not in the smart phone 229, unless the user presses a ‘save’ button in the application, which is also shown in FIG. 8. The data is saved into the selected user account 401. FIG. 9 shows a data summary interface which can be made to appear when the data is saved (the data are all set to zero as this is only an illustrative example).

Typically, the default mode when the bathroom scale 101 is awakened is the Weight Measurement Mode and not Body Fat Measuring Mode. The user can shake the smart phone 229 to cause the bathroom scale 101 to switch over to Body Fat Measuring Mode.

Accordingly, the embodiment provides several advantages. Without having to perform a physical key button pressing, or touching action, or by any mechanical type of action on the bathroom scale, the user is able to choose his user account 401 by using a smart phone 229. By shaking or swaying the smart phone 229 near the bathroom scale, the smart phone 229 can wirelessly indicate the selected user account 401 to the bathroom scale 101. Then, the bathroom scale can synchronize information between the bathroom scale and the application for the same user account.

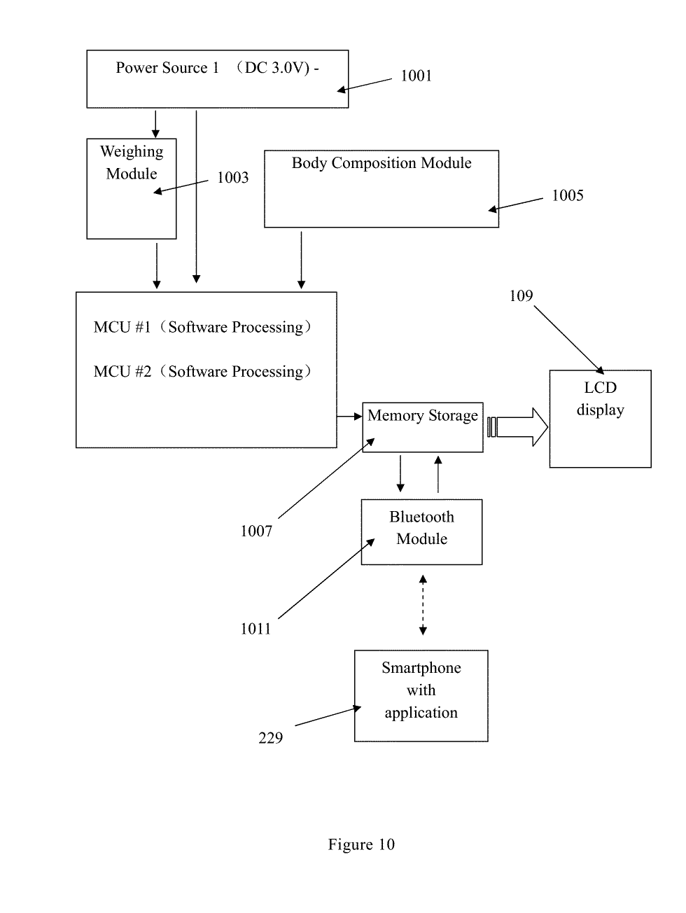

FIG. 10 is a schematic diagram showing one possible internal structure of the bathroom scale 101. There are two modes of operation in the bathroom scale, the Weight Measurement Mode 1003 and the Body Fat Measuring Mode 1005. A power source 1001 is provided for powering up the bathroom scale 101. Typically, there are two microcontroller units, MCU#1 and MCU#2 in the bathroom scale 101. MCU #1 is for software processing of the following processes:

1. Monitoring battery power level
2. System status monitoring & calibrating.
3. Detect & capture signal for weighing & convert to digital output

MCU #2 is for software processing of the following processes:

1. Keying in/Retrieving storage of personal data setting (Age, Height, Gender, Weight.)
2. Detecting & capturing signals of Bio Impedance value.
3. Processing & calculating Personal Body Fat, Body Water, Muscle Mass, Bone Mass, Metabolic Rate
4. Convert all data to digital output

A memory 1007 is provided which stores user accounts 401 and the personal data of the users. An LCD display 109 is provided which allows the user to interact with the bathroom scale 101. Data stored in the memory 1007 can be selected and shown in the display, as in the processes described in FIG. 2. A Bluetooth module 1011 is provided which allows the bathroom scale 101 to communicate with an external device, such as the smart phone 229.

Although a smart phone 229 is described, other embodiments is envisaged to be within the scope of this specification, including other portable devices like Personal Digital Assistants, watches capable of wireless communication, all containing an application or some other functional modules for communicating with the bathroom scale 101. Preferably, these portable devices are able to detect a shaking movement to trigger synchronization of data with the bathroom scale.

Although a bathroom scale 101 is described, other embodiments are envisaged to be within the scope of this specification, including body fat bathroom scale or any other type of weighing apparatus serving a similar purpose. Therefore, while there has been described in the foregoing description preferred embodiments of the present invention, it will be understood by those skilled in the technology concerned that many variations or modifications in details of design, construction or operation may be made without departing from the scope of the present invention as claimed.

1. A method of communicating with a bathroom scale, comprising the step of:
providing a remote controller,
establishing communication between a bathroom scale and the remote controller;
using the remote controller to obtain the reading on the bathroom scale; and
displaying the reading on the remote controller.

2. A method as claimed in claim 1, wherein the bathroom scale has a memory suitable for storing records of the weight of users in a plurality of user accounts, further comprising the step of allowing a user to select a user account using the remote controller;

3. A method as claimed in claim 2, further comprising the step of: uploading data in the memory of the bathroom scale into the remote controller.

4. A method as claimed in claim 3, wherein the communication between the remote controller and the bathroom scale is wireless.

5. A method as claimed in claim 4, wherein the remote controller is a portable device.

6. A method as claimed in claim 5, wherein the remote controller is a smart phone.

7. A method as claimed in claim 6, further comprising the step of shaking the smart phone to trigger an application suitable to establish communication between the bathroom scale and the remote controller and to identify the selected user account as the current user of the bathroom scale.

8. A remote controller for obtaining physical data from a bathroom scale, wherein the remote controller is configured to communicate with the bathroom scale.

9. A remote controller for obtaining physical data from a bathroom scale as claimed in claim 8, wherein the remote controller is useable to select an user account from a plurality of user accounts in the bathroom scale.

10. A remote controller for obtaining physical data from a bathroom scale as claimed in claim 9, wherein
the bathroom scale has a memory suitable for storing records of the weight of a plurality of users in respective user accounts; and
the remote controller is configured to communicate with the bathroom scale in order to upload data in the memory of the bathroom scale into the remote controller.

11. A remote controller for obtaining physical data from a bathroom scale as claimed in claim 10, wherein the remote controller is capable of communicating with the bathroom scale wirelessly.

12. A remote controller for obtaining physical data from a bathroom scale as claimed in claim 11, wherein the remote controller is a portable device.

13. A remote controller for obtaining physical data from a bathroom scale as claimed in claim 12, wherein the remote controller is a smart phone.

14. A remote controller for obtaining physical data from a bathroom scale as claimed in claim 13, wherein
the smart phone is able to detect a user shaking the smart phone,
the smart phone configured to trigger an application suitable for the establishing of communication between the bathroom scale and the remote controller when the shaking is detected; and
the remote controller is useable to select an user account for use with the bathroom scale by the triggered application identifying the user to the bathroom scale.

15. A bathroom scale comprising
a remote controller; and
a transducer for uploading data obtained by the bathroom scale to the remote controller.

16. A bathroom scale as claimed in claim 15, wherein the transducer is a wireless communication transducer, and further comprising
a memory suitable for storing records of a weight of each of a plurality of users; wherein
the wireless communication transducer is configured to detect a user identity transmitted from the remote controller, such that
the wireless communication transducer uploads data obtained by the bathroom scale of the identified user to the remote controller.

17. A bathroom scale as claim in claim 16, wherein the transducer is a wireless transducer.

18. A bathroom scale as claim in claim 17, wherein the remote controller is a portable device.

19. A bathroom scale as claim in claim 17, wherein the remote controller is a smart phone.
